(19) United States
(12) Patent Application Publication
(10) Pub. No.: US 2020/0143427 A1
(43) Pub. Date: May 7, 2020

(54) TAGGED CONTENT DISTRIBUTION

(71) Applicant: ENT. SERVICES DEVELOPMENT CORPORATION LP, Houston, TX (US)

(72) Inventors: Joshua HAILPERN, Sunnyvale, CA (US); William J. ALLEN, Corvallis, OR (US)

(73) Assignee: ENT. SERVICES DEVELOPMENT CORPORATION LP, Houston, TX (US)

(21) Appl. No.: 15/740,796

(22) PCT Filed: Dec. 30, 2015
(86) PCT No.: PCT/US2015/038507

§ 371 Date: Apr. 6, 2018

(51) Int. Cl. G06Q 30/02; G06Q 50/00; H04L 12/58

(52) U.S. Cl. CPC G06Q 30/0269; G06Q 30/0255; H04L 51/14; H04L 51/10; G06Q 50/01

(57) ABSTRACT

Examples associated with tagged content distribution are disclosed. One example includes a network generation module that builds an implicit network of user relationships based on explicit interactions between users of an enterprise communication network. The example includes a content sharing module to detect a content tag associated with a tagged artifact distributed via the enterprise communication network. The content sharing module also distributes the tagged artifact to users of the enterprise communication network that have expressed interest in the content tag. The example also includes a content recommendation module to recommend the tagged artifact to users of enterprise communication network based on, for example, user relationships, content tags with which users have expressed interest, and so forth.

### BACKGROUND

Social networks are used by individuals to keep up with acquaintances and to share content with one another, among other uses. These networks may be built by individuals explicitly linking each other by, for example, mutually accepting friend requests. This creates a large graph of relationships that businesses may use to, for example, target advertisements, disseminate information, and so forth.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example network, on which example systems, and methods, and equivalents, may operate.

FIG. 2 illustrates an example system associated with tagged content distribution.

FIG. 3 illustrates another example system associated with tagged content distribution

FIG. 4 illustrates a flowchart of example operations associated with tagged content distribution.

FIG. 5 illustrates another flowchart of example operations associated with tagged content distribution.

FIG. 6 illustrates an example computing device in which example systems, and methods, and equivalents, may operate.

### DETAILED DESCRIPTION

Systems, methods, and equivalents associated with tagged content distribution are described. Today, many businesses attempt to leverage social networks internally by, for example, deploying a proprietary social network over an internal network. These internal social networks provide value to the business by providing visibility to company projects, increasing collaboration within the company, and delivering a forum for people interested in various corporate aspects to discuss the aspects privately within the company asynchronously, and in potentially large groups.

However, sometimes these social networks do not become popularly used or widely adopted within a corporate environment. One reason for this may be because some social networks use affirmative actions by users to build the network and leverage the network. For example, to store a relationship between two users, many social networks have one or both users confirm the relationship between the two users. This may, for example, maintain privacy, ensure both users know each other, and so forth. Further, users of the corporate social network may not see the network as a value add to their day to day lives, as compared with an external social network which may allow a user to, for example, stay in touch with friends and family. Users may also not be interested in sharing personal interests over the corporate network. Additionally, sharing content over explicit social networks may take steps (e.g., logging in, setting up, uploading a picture, uploading content) that some users do not find worth the time and/or effort.

Consequently, instead of users building the network through explicit actions, a company may leverage internal services (e.g., email, instant messaging) to build an implicit social network from explicit user actions that are not directly related to the social network. By way of illustration, upon detecting an email exchange between two users, a relationship between these two users may be added to the implicit social network. The more emails between the two users, the stronger the link may be. As the social network is built, using relationships derived from regular day to day actions of users, the company may then be able to drive value from the social network.

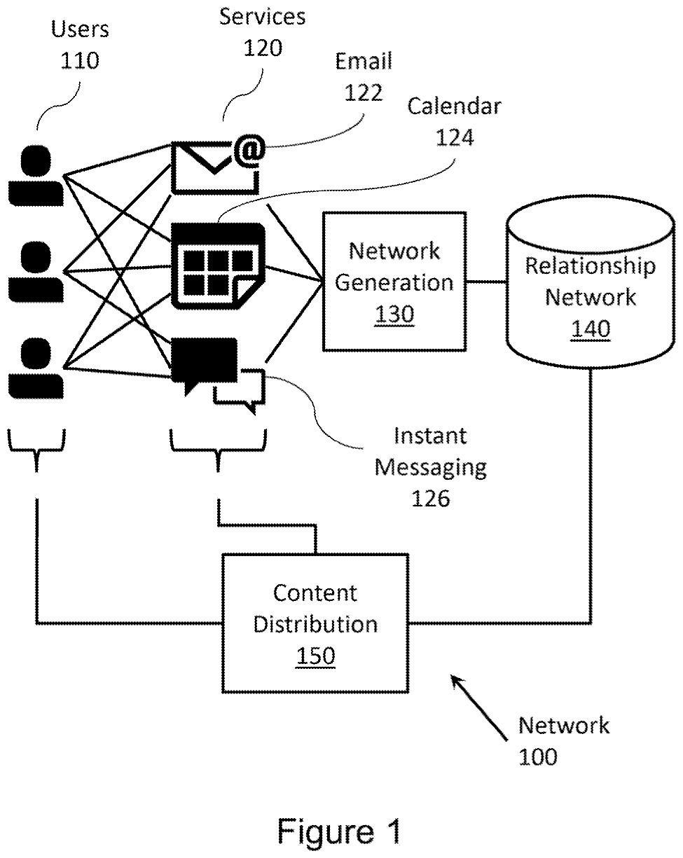

FIG. 1 illustrates an example network 100 on which example systems and methods, and equivalents, may operate. It should be appreciated that the items depicted in FIG. 1 are illustrative examples and many different features and implementations are possible.

FIG. 1 illustrates an example network 100. Network 100 includes aspects of a company's internal network that provides services to users 110 of network 100. Consequently, users 110, may be employees of the company that has deployed various aspects of network 100. Network 100 also includes several services 120. In this example, the services include an email service 122, a calendar service 124, and an instant messaging service 126. Services 120 may also include other services, not shown, that depend on the types of tools that the company has deployed into network 100 (e.g., shared documents). Generally, services 120 may facilitate communication and/or collaboration between the users 110.

To further encourage collaboration between users 110, the company may seek to leverage some social network technologies, including content sharing, and relationship recommendations. However, users 110 have limited time and may not participate in a social network that involves explicitly managing relationships and/or connections. Consequently, this may prevent the internal social network from reaching a critical mass of users 110, and/or use that will provide a suitable justification for users 110 of the social network to gain value from using the social network.

Instead, the company may employ a social network that is built on top of the services 120 and derives connections within the social network based on interactions between users 110 over the services 120. Consequently, the services 120 within network 100 may feed into a process that performs network generation 130. In various examples, network generation 130 may monitor interactions between users 110 via services 120. By way of illustration, even without viewing the content of communications passed via services 120, network generation logic may note when, for example, two users 110 communicate via email service 122, two users 110 schedule a calendar appointment via calendar service 124, two users 110 communicate via instant messaging service 126, and so forth.

Based on these interactions, network generation 130 may build a relationship network 140. Relationship network 140 may be structured, for example, as a graph of relationships between users 110 of network 100, where nodes represent users 110 and edges represent relationships between users 110. In various examples, edges between the users 110 may represent forms of communication between users 110, frequency of communications between users 110, and so forth. Consequently, network generation 130 may build an implicit social network (e.g., relationship network 140) from the explicit interactions between users 110 as users 110 go about their day to day tasks working for the company. In some examples, network generation 130 may also facilitate connecting users 110 explicitly based on affirmative actions to connect users 110 by those users 110.

Now that relationship network 140 has been built by network generation 130, a process for content distribution 150 may operate within network 100 to facilitate the collaboration desired by the company employing network 100. Content distribution 150 may rely on a variety of tools and mediums to facilitate sharing content between users 110.

In one example, users may trigger content distribution 150 by tagging artifacts within content as the content is transmitted by services 120. This may cause content distribution 150 to extract the tagged artifacts from the content based on content tags associated with the tagged artifacts, and distribute the tagged artifacts to users 110.

As used herein, an artifact refers to content that is to be distributed over a social network. The artifact may be or include, text, images, video, audio, and so forth. An artifact may be distinct from content in which the artifact is embedded. For example, a text artifact to be distributed may be extracted from a longer piece of text content based on, for example, content tag locations within the longer piece of text content, punctuation of the text content, and so forth.

Thus, tagging artifacts may include embedding a tag within the artifact intended to be distributed via content distribution 150. In some examples, the tag may be a hashtag, though other methods of content tagging may also be appropriate. A hashtag may be formed by a number or pound symbol, “#”, followed by a word, an abbreviation, an initialism, a phrase with removed internal spacing, and so forth that describes the tag. By way of illustration, hashtags associated with patents may include, for example “# Patent”, “# PatLaw”, “# USPTO”, “# PatentLaw”, and so forth.

By embedding a tag into an artifact, content distribution 150 may recognize that the tagged artifact is intended to be distributed to users 110 who might be interested in that tag. Content distribution 150 may rely on a variety of information for determining users 110 that might be interested in various tags. In some examples, users 110 might explicitly indicate interest in tags, and “follow” the tags using some tool or application that interfaces with content distribution 150 and provided to users 110 by the company operating network 100. In other examples, users 110 interested in tags may be identified based on relationship network 140. By way of illustration, a user may be interested in tagged artifacts distributed by other users 110 with whom that user regularly communicates via services 120. In other examples, users 110 who follow certain tags may be interested in artifacts distributed via related content tags. Whether tags are related may be determined by, for example, users 110 who distribute content via the tag, content of artifacts associated with the tags, and so forth.

In another example, a user may tag content by directly sending it to a tag (e.g., via an email, via a tagging tool). This form of tagging content may allow users to more explicitly delimit the content they seek to distribute via a content tag.

As discussed above, to cause content distribution 150 of an artifact, a user 110 may insert a content tag into the artifact prior to distributing the content tag via a service 120. This may effectively push the tagged artifact to users 110 who have expressed interest in the content tag and those who may be interested in the content tag. To identify the scope of the tagged artifact, upon detecting tagged content, content distribution 150 may isolate the artifact and extract the tagged artifact from content in which the tagged artifact resides. By way of illustration, a tag detected in an email may cause a portion (e.g., a sentence, a paragraph) of that email to be treated as a tagged artifact by content distribution 150. In another example, a tag detected in a PowerPoint presentation may cause a slide on which the tag resides to be treated as a tagged artifact for distribution. Limiting the scope of tagged artifacts may allow users to limit what content is distributed by content distribution 150 when tagging certain content in an otherwise private communication. Further, extracting artifacts from content distributed via services based on content tags may facilitate seamless distribution of content while limiting the actions used to distribute content distribution a burdensome task on users 110.

Once a tagged artifact has been distributed to users, these users may be able to access the tagged artifact, discuss the tagged artifact, manipulate the tagged artifact, and so forth. This may encourage collaboration within a company operating the network by connecting people based on shared content. Further, as users interact with one another regarding a specific content tag and/or tagged artifact, connections to the social network may be added based on these interactions.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include one or more gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

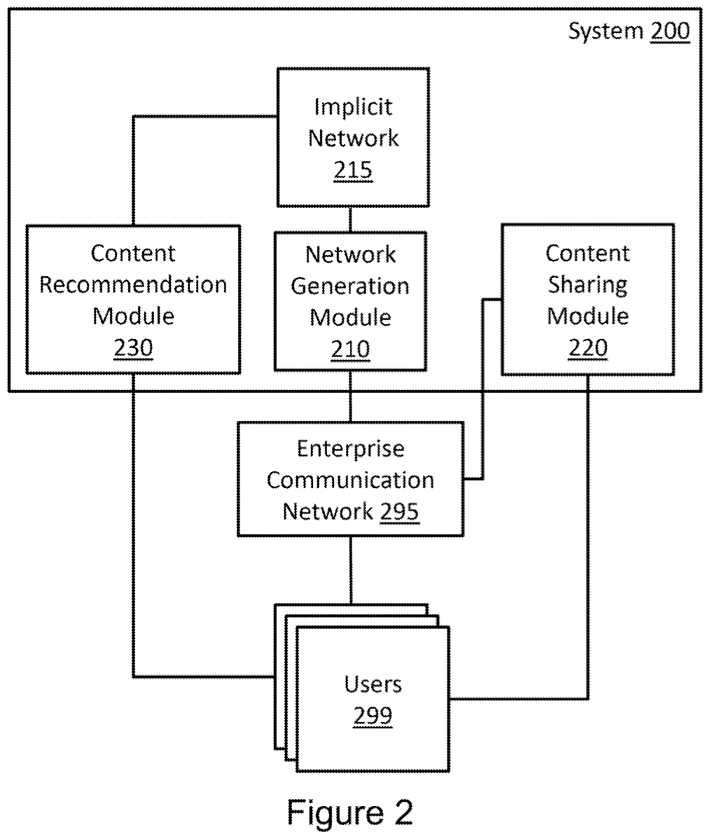

FIG. 2 illustrates an example system 200 associated with tagged content distribution. System 200 includes a network generation module 210. Network generation module 210 may build an implicit network 215 of user relationships. Implicit network 215 may be built based on explicit interactions between users 299 of an enterprise communication network 295. Enterprise communication network 295 may include, for example, an email application, an instant message application, a text message application, a calendar application, a collaboration application, and so forth.

System 200 also includes a content sharing module 220. Content sharing module 220 may detect a content tag associated with a tagged artifact. The tagged artifact, may be, for example, text, a slide from a presentation, an image, a video, and so forth. The content tag may be detected when the tagged artifact is distributed via enterprise communication network 295. In various examples, content sharing module 220 may identify a scope of the tagged artifact based on proximity of portions of the tagged artifact to the content tag. Content sharing module may then distribute the tagged artifact to users 299 of enterprise communication network 295 that have expressed interest in the content tag.

System 200 also includes a content recommendation module 230. Content recommendation module 230 may recommend the tagged artifact to users 299 of enterprise communication network 295 based on, for example, the implicit network of user relationships 215, content tags with which users have expressed interest, and so forth.

In various examples, network generation module 210, content sharing module 220, and content recommendation module 230 may interact with artifacts distributed through enterprise communication network 295 in a variety of ways. In one example, a server plugin may interface enterprise communication network 295 with the modules 210, 220, and 230. In another example, an addon to the enterprise communication network 295 may interface with the modules 210, 220, and 230. In another example, a proxy server may intercept traffic between the modules 210, 220, and 230, and enterprise communication network 295. Alternatively, client plugins associated with machines, operated by users 299 and interacting with enterprise communication network 295, may perform various functions associated with modules 210, 220, and 230. Further, a wrapper client to enterprise communication network 295 may interface with the modules 210, 220, and 230. Other techniques for interfacing the modules 210, 220, and 230 with enterprise communication network 295 may also be possible.

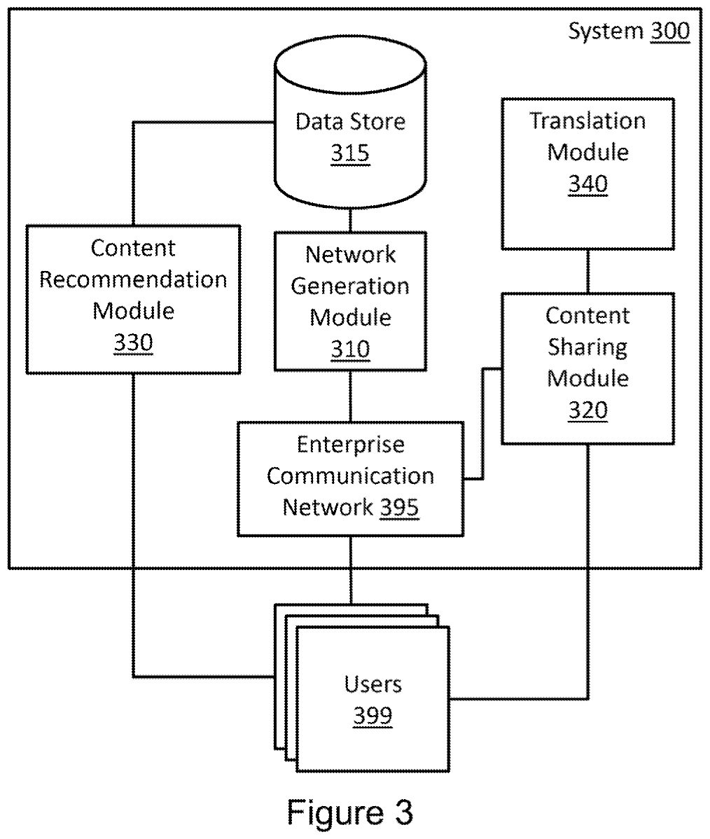

FIG. 3 illustrates a system 300. System 300 includes several items similar to those described above with reference to system 200 (FIG. 2). For examples, system 300 includes a network generation module 310 that generates an implicit network of user relationships based on communications from users 399 over an enterprise communication network 395, a content sharing module 320 to distribute a tagged artifact to users 399 based on content tags with which users 399 have expressed interest, and content recommendation module 330.

System 300 also includes a data store 315. Data store 315 may store the network of user relationships. Additionally, data store 315 may also store the content tags with which users 399 have expressed interest. System 300 also includes a translation module 340. Translation module 340 may translate at least one of the content tags and the tagged artifact. In this example, system 300 also includes the enterprise communication network 395.

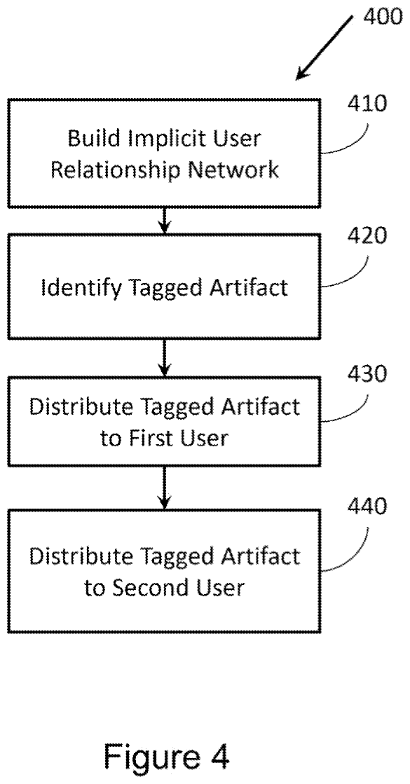

FIG. 4 illustrates an example method 400 associated with tagged content distribution. Method 400 may be embodied on a non-transitory computer-readable medium storing computer-executable instructions. The instructions, when executed by a computer, may cause the computer to perform method 400. In other examples, method 400 may exist within logic gates and/or RAM of an application specific integrated circuit (ASIC).

Method 400 includes building an implicit user relationship network at 410. The implicit user relationship network may be built from explicit interactions between users of an enterprise communication network. These explicit interactions may include, an email exchange between two or more users, scheduling of a meeting involving two or more users, collaboration between two or more users and a project, and so forth.

Method 400 also includes identifying a tagged artifact at 420. The tagged artifact may be identified based on a proximity of the tagged artifact to a content tag. The tagged artifact may be obtained from a variety of types of content. For example, the tagged artifact may be obtained from a text document. In this example, proximity of the content tag may be identified based on punctuation of the text document near the content tag. In another example, the tagged artifact may be obtained from a deck of presentation slides. In this example, proximity of the tagged artifact to the content tag may be identified based on a slide of the deck of presentation slides on which the content tag is placed. In another example, the tagged artifact may be obtained from a streaming media (e.g., audio, video). In this example, proximity of the tagged artifact to the content tag is identified based on a location of the content tag within the streaming media.

Method 400 also includes distributing the tagged artifact at 430. The tagged artifact may be distributed to a first user of the enterprise communication network. The first user may have expressed interest in the content tag. A user may express interest in a content tag, by, for example, following the content tag, accessing content associated with the content tag, and so forth.

Method 400 also includes distributing the tagged artifact at 440. At 440, the tagged artifact may be distributed to a second user of the enterprise communication network. The tagged artifact may be distributed to the second user based on, for example the implicit network of user relationships, tags with which the second user has expressed interest, and so forth.

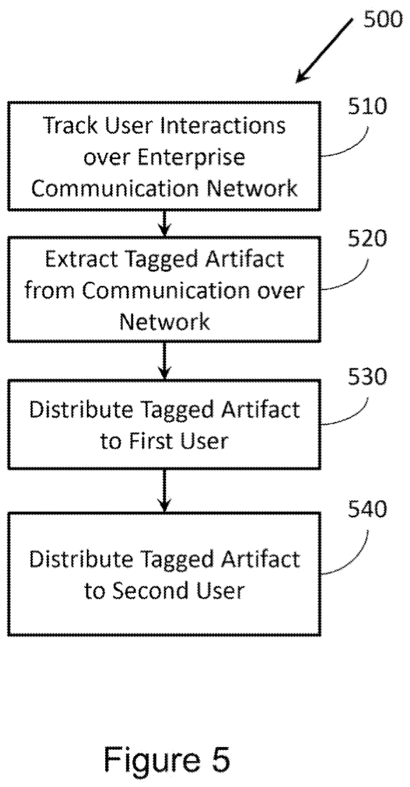

FIG. 5 illustrates a method 500 associated with tagged content distribution. Method 500 includes tracking when users of an enterprise communication network interact at 510. Tracking the interactions of the users of the enterprise communication network may facilitate building a graph of relationships between the users of the enterprise communication network.

Method 500 also includes extracting a tagged artifact from a communication distributed via the enterprise communication network at 520. The tagged artifact may be identified by a content tag in the communication. In various examples, the content tag may have been embedded in the communication by an entity (e.g., a user, a logic) that distributed the communication over the enterprise communication network. In some examples, the content tag may be, for example, a hashtag. A hashtag may be noted by a pound or number symbol (i.e., “#”) followed by an alphanumerical description of the topic to which the tagged artifact relates. By way of illustration, tagged artifacts related to the topic of American Sign Language may be accompanied by a “# ASL” hashtag, a “# AmericanSignLanguage” hashtag, and so forth.

Method 500 also includes distributing the tagged artifact to a first user at 530. The first user may be a user who had previously expressed interest in the content tag that was embedded in the communication distributed over the enterprise communication network. In the example, where the content tag is a hashtag, the first user may express interest in the content tag by following the hashtag. The first user following the hashtag may cause a logic to trigger when tagged artifacts tagged with the hashtag. In various examples, this triggered logic may cause tagged artifacts to be forwarded directly to the first user (e.g., via a feed, via email), cause the tagged artifacts to be displayed on a webpage when the first user accesses that webpage, and so forth. In other examples, the first user may express interest in the content tag by accessing content associated with the content tag. In this example, the first user accessing content associated with the content tag may create a record of content in which the first user is interested. This may make it likely that the first user will be interested in other content related with the content tag, making it valuable to the first user to the tagged artifact despite not expressing interest in the content tag through an explicit action.

Method 500 also includes distributing the tagged artifact to a second user at 540. The second user may be identified based on, for example, content tags in which the second user expressed an interest, other users of the enterprise communication network to whom the second user is related in the relationship graph, and so forth.

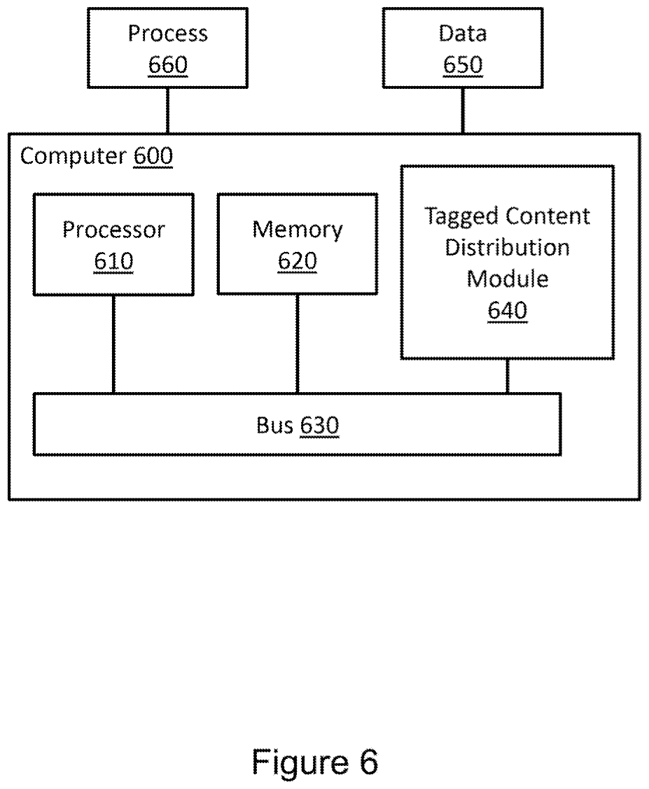

FIG. 6 illustrates an example computing device in which example systems and methods, and equivalents, may operate. The example computing device may be a computer 600 that includes a processor 610 and a memory 620 connected by a bus 630. The computer 600 includes a tagged content distribution module 640. Tagged content distribution module 640 may perform, alone or in combination, various functions described above with reference to the example systems, methods, apparatuses, and so forth. In different examples, tagged content distribution module 640 may be implemented as a non-transitory computer-readable medium storing computer-executable instructions, in hardware, software, firmware, an application specific integrated circuit, and/or combinations thereof.

The instructions may also be presented to computer 600 as data 650 and/or process 660 that are temporarily stored in memory 620 and then executed by processor 610. The processor 610 may be a variety of various processors including dual microprocessor and other multi-processor architectures. Memory 620 may include non-volatile memory (e.g., read only memory) and/or volatile memory (e.g., random access memory). Memory 620 may also be, for example, a magnetic disk drive, a solid state disk drive, a floppy disk drive, a tape drive, a flash memory card, an optical disk, and so on. Thus, memory 620 may store process 660 and/or data 650. Computer 600 may also be associated with other devices including other computers, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A system, comprising:
a network generation module to build an implicit network of user relationships based on explicit interactions between users of an enterprise communication network;
a content sharing module to detect a content tag associated with a tagged artifact distributed via the enterprise communication network, and to distribute the tagged artifact to users of the enterprise communication network that have expressed interest in the content tag; and
a content recommendation module to recommend the tagged artifact to users of the enterprise communication network based on at least one of the implicit network of user relationships and content tags with which users have expressed interest.

2. The system of claim 1, where the enterprise communication network comprises one of an email application, an instant message application, a text message application, a calendar application, and a collaboration application.

3. The system of claim 1, where the content sharing module identifies a scope of the tagged artifact based on proximity of portions of the tagged artifact to the content tag.

4. The system of claim 1, comprising a data store to store the network of user relationships and to store data describing the content tags with which users have expressed interest.

5. The system of claim 1, comprising a translation module to translate at least one of the content tags and the tagged artifact.

6. The system of claim 1, comprising the enterprise communication network.

7. The system of claim 1, where the network generation module, the content sharing module, and the content recommendation module interact with artifacts distributed through the enterprise communication network via one of, a server plugin to the enterprise communication network, an addon to the enterprise communication network; a proxy server that intercepts traffic headed to the enterprise communication network; client plugins associated with users that interact with the enterprise communication network; and a wrapper client to the enterprise communication network.

8. The system of claim 1, where the tagged artifact is one of, text, a slide, an image, and a video.

9. A method, comprising:
building an implicit user relationship network from explicit interactions between users of an enterprise communication network;
identifying a tagged artifact based on a proximity of the tagged artifact to a content tag;
distributing the tagged artifact to a first user of the enterprise communication network that has expressed interest in the content tag; and
distributing the tagged artifact to a second user of the enterprise communication network based on at least one of the implicit network of user relationships, and on tags with which the second user has expressed interest.

10. The method of claim 9, where the tagged artifact is obtained from a text document and where proximity of the tagged artifact to the content tag is identified based on punctuation of the text document near the content tag.

11. The method of claim 9, where the tagged artifact is obtained from a deck of presentation slides, and where proximity of the tagged artifact to the content tag is identified based on a slide from the deck of presentation slides on which the content tag is placed.

12. The method of claim 9, where the tagged artifact is obtained from a streaming media, and where proximity of the tagged artifact to the content tag is identified based on a location of the content tag within the streaming media.

13. A non-transitory computer-readable medium storing computer-executable instructions that when executed by a computer cause the computer to:
track when users of an enterprise communication network interact to build a relationship graph;
extract a tagged artifact from a communication distributed via the enterprise communication network, the tagged artifact identified by a content tag in the communication;
distribute the tagged artifact to a first user who expressed interest in the content tag; and
distribute the tagged artifact to a second user based on at least one of, content tags with which the second user has expressed interest, and a third user with whom the second user is related in the relationship graph.

14. The non-transitory computer-readable medium of claim 13, where the content tag is a hashtag, and where the first user expresses interest in the content tag by following the content tag.

15. The non-transitory computer-readable medium of claim 13, where the first user expresses interest in the content tag by accessing tagged artifacts associated with the content tag.
